(19) United States
(12) Patent Application Publication
(10) Pub. No.: US 2006/0045165 A1
(43) Pub. Date: Mar. 2, 2006

(54) Thermal interface material characterization system and method

(76) Inventors: Gary K. Chan, Palo Alto, CA (US); Don Nguyen, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/929,161

(22) Filed: Aug. 30, 2004

(51) Int. Cl. G01K 17/00; G01N 3/00

(52) U.S. Cl. 374/43; 374/29; 374/46

(57) ABSTRACT

A thermal interface material characterization system comprises two thermal heads. A thermal interface material is disposed between the thermal heads. A plurality of thermal sensors is disposed within one of the thermal heads. Another plurality of thermal sensors is disposed within the other thermal head. The thermal sensors generate temperature data along an axis in a direction of heat flow through the thermal heads. A thermal characteristic of the thermal interface material can be determined from the temperature data generated from the thermal sensors.

### BACKGROUND

Many integrated circuits (ICs) generate such a high amount of heat that it is necessary to attach a heat sink to an exposed side of the package containing the IC in order to enhance heat dissipation from the IC package and facilitate reliable and long-term performance of the IC. To ensure a good connection for thermal conduction, a thermal interface material (TIM) is placed between the IC package and the heat sink. The thermal resistance of the TIM is, thus, of high importance and critical consideration for selecting the best TIM to facilitate heat conduction across the contact interface between the IC package and the heat sink.

In some industries, manufacturers prefer to incorporate new ICs into products as quickly as possible. Therefore, the ability to select the best TIM as quickly as possible contributes to the shortest time-to-market for new product development. It is, therefore, important to be able to test new TIMs in order to determine the relevant characteristics of the TIMs, such as thermal resistance and thermal conductivity, so the preferred TIM can be quickly selected for each new product.

Certain test standards (e.g. ASTM D5470 family of tests) have been developed by ASTM (American Society for Testing and Materials) and ANSI (American National Standards Institute) in an attempt to standardize test procedures. With such tests, it is hoped that manufacturers of TIMs can characterize the TIMs for the benefit of other manufacturers who may incorporate those TIMs into new products. However, in spite of the existence of testing standards, there is a lack of agreement in the industry on any single test method to adequately characterize TIMs for specific applications. Additionally, reliable equipment for the standards has been difficult to build. Also, there has been considerable discrepancy in the results of the standardized tests between different testers and different test apparatus, so the test results are not always reliable. Following the standard test methodologies does not always produce accurate results for high performance materials. In fact, round-robin tests using the ASTM D5470 standard methodology have demonstrated repeatability errors within labs of between 10-20%, and reproducibility errors from lab to lab of between 20-40%. Furthermore, the standardized tests do not adequately reflect “real-world” conditions in which the TIMs may be used. In particular, the pressures to which the TIMs are subjected during testing are considerably higher than the pressures to which the TIMs are typically subjected in an actual application. The pressure, however, can significantly affect the thermal resistance of the TIM, so the standardized tests, even when properly performed, may not provide useful results.

The various available TIM characterization tests are generally divided into two groups—dynamic (a.k.a. transient) tests and steady state tests. In steady state tests, the test equipment and the TIM being tested reach steady state temperature and pressure conditions before data is taken. The ASTM D5470 standard test is an example of a steady state test method. In transient tests, the data is taken before steady state conditions are reached. Thus, the transient tests may generally be faster than the steady state tests, since these tests do not require waiting for steady state conditions. However, the transient tests are not necessarily more accurate than the steady state tests. Additionally, the transient tests do not properly reflect real-world conditions under which the TIMs are expected to operate. Under such conditions, for example, the IC package, the TIM and the heat sink primarily operate under relatively stable conditions. Also, the thermal resistance of the TIM can vary with temperature variations, so the transient tests cannot give useful results if they do not take into consideration the anticipated temperature range to which the TIM will be subjected in real-world conditions. Furthermore, transient tests do not work with TIMs that undergo a phase change, because the TIM is not allowed to melt and settle for a few minutes prior to collecting data.

An exemplary transient test apparatus includes hot and cold thermal heads between which the TIM under test is placed.- A heater heats the hot thermal head, and a cooling plate cools the cold thermal head. In this manner, heat flows through the TIM between the two thermal heads. Thermal sensors (one in each thermal head) are placed at or near the surfaces that contact the test TIM. With such an apparatus, to be able to determine the relevant thermal characteristics (e.g. thermal resistance, thermal conductivity, etc.) of a test TIM for which the thermal resistance is unknown, the apparatus is calibrated by running the test without a TIM between the thermal heads or by using a known TIM with a known thermal resistance. In this case, calculations required to determine the relevant thermal characteristics of the test TIM are, thus, not made directly from the measurements taken during the test of the TIM, but must also include the calibration data. Upon starting the test, a pulse of energy (heat) is applied to the hot thermal head and the dynamic (i.e. time-dependent) temperature response at each sensor is monitored. The temperature response of the cold thermal head relative to the temperature response of the hot thermal head is a function of the thermal resistance of the test TIM. The thermal resistance of the test TIM, thus, may be indirectly determined by comparing the sensor temperature responses when the test TIM is used with the sensor temperature responses when a known TIM (with a known thermal resistance) is used. Alternatively, a calculation based on the amount of power supplied to the heater may be used to indirectly determine the relevant thermal characteristics of the test TIM.

An exemplary steady state test apparatus that has been used includes an IC package and a heat sink between which the TIM under test is placed. The IC package may be either a real IC package or a dummy IC package. The real IC package contains a copy of the IC that will be used in the real-world conditions, so in order to generate heat for the test, the IC is powered up and run under an exemplary operation situation. The dummy IC package, on the other hand, resembles the real IC package on the exterior, but has a heater inside which is powered up to simulate the heat generation of the real IC package. To assemble the test apparatus with either IC package, a thermal sensor is glued onto the surface of the IC package. Another thermal sensor is glued onto the surface of the heat sink. To make room for the dimensions of the thermal sensors and wires connected to the thermal sensors, a hole or groove is drilled or machined into the heat sink. The hole or groove and the thermal sensors and wires must be very carefully and precisely formed in or placed on the heat sink and IC package. The heat sink is mounted onto the IC package with the test TIM in between. This assembly procedure must be repeated every time this type of test is performed. Since there are several manual steps to perform, this test procedure is time consuming and there is considerable opportunity for human error to be introduced. In fact, actual performance of this test procedure has demonstrated that a significant variation in results can occur even when the test procedure is repeated a second time in the same manner as it was performed the first time.

### BRIEF DESCRIPTION OF THE DRAWINGS

FIG. 1 is a side view of a simplified computer system incorporating an exemplary IC package and heat sink with a thermal interface material in between.

FIG. 2 is a side view of a thermal interface material characterization system according to an embodiment of the present invention.

FIG. 3 is a side view of a test apparatus according to an embodiment of the present invention and incorporated in the thermal interface material characterization system shown in FIG. 2.

FIG. 4 is another side view of the test apparatus shown in FIG. 3 according to an embodiment of the present invention.

FIG. 5 is a side view of thermal head assemblies according to an embodiment of the present invention and incorporated in the test apparatus shown in FIG. 3.

FIG. 6 is a side view of thermal heads according to an embodiment of the present invention and incorporated in the thermal head assemblies shown in FIG. 5.

FIG. 7 is a simplified schematic of a control system according to an embodiment of the present invention and incorporated in the thermal interface material characterization system shown in FIG. 2.

FIG. 8 is a simplified schematic of another control system according to an alternative embodiment of the present invention and incorporated in the thermal interface material characterization system shown in FIG. 2.

FIG. 9 is a simplified flow chart for operation of the thermal interface material characterization system shown in FIG. 2 according to an embodiment of the present invention.

FIG. 10 is another simplified flow chart for operation of the thermal interface material characterization system shown in FIG. 2 according to an alternative embodiment of the present invention.

### DETAILED DESCRIPTION

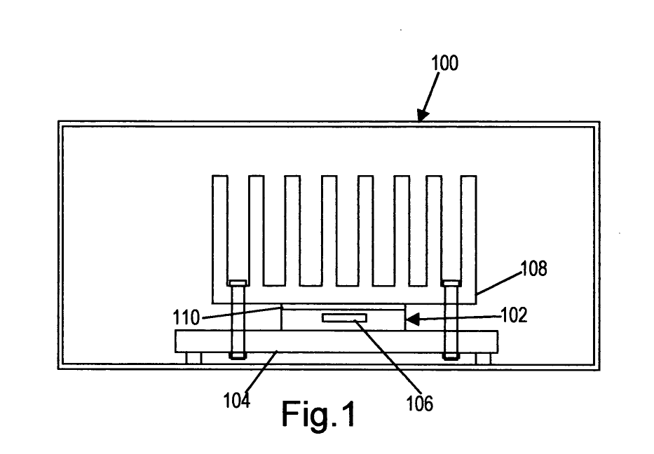

In a computer system 100, or other appropriate electronic device, an integrated circuit (IC) package 102 is commonly mounted onto a circuit board 104, as shown in FIG. 1. The IC package 102 includes an IC die 106 that consumes electrical power and as a byproduct generates heat within the computer system 100. To assist in dissipating the heat from the IC package 102, a heat sink 108 is mounted onto the IC package 102, so that the heat generated by the IC die 106 within the IC package 102 can be quickly conducted away from the IC package 102. To ensure a good thermal connection between the IC package 102 and the heat sink 108, a thermal interface material (TIM) 110 is placed in the interface between the IC package 102 and the heat sink 108. Selection of the TIM 110 generally depends on the cost of the TIM 110, the ease of assembling and disassembling the combined IC package 102 and heat sink 108 with the TIM 110 in between and the relevant thermal characteristics, or properties, of the TIM 110 that render the TIM 110 more or less suitable, or qualified, to be used in a given application.

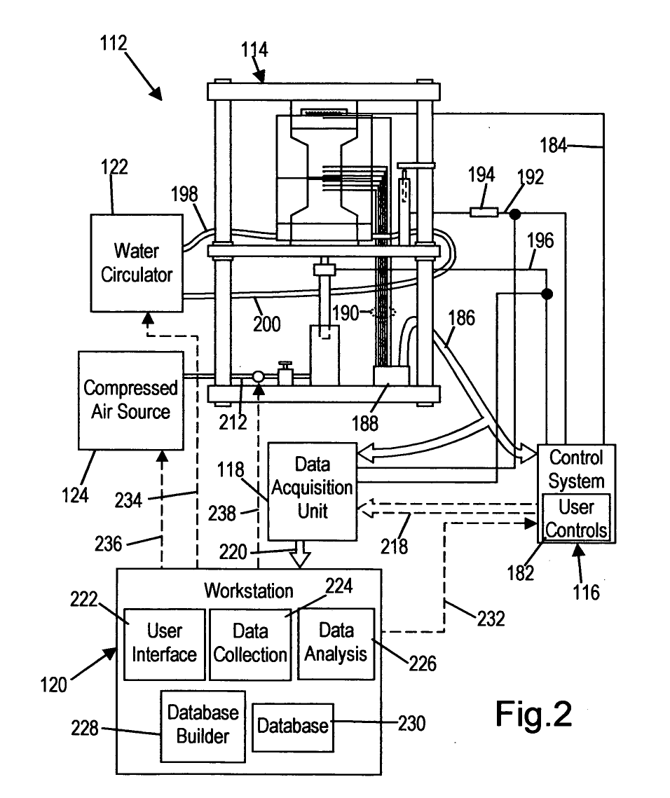

The embodiments of the thermal interface material characterization system 112 (FIG. 2) and method described and shown herein enable the discovery of the relevant thermal characteristics of a wide variety of TIMs. Although the relevant thermal characteristics and the testing of TIMs are described herein with respect to qualifying the TIMs for use as shown by the TIM 110 in FIG. 1, it is understood that the invention is not limited only to testing the TIMs for this single purpose, but may be used to characterize any appropriate material for use in any appropriate situation in which the material's thermal characteristics are at issue.

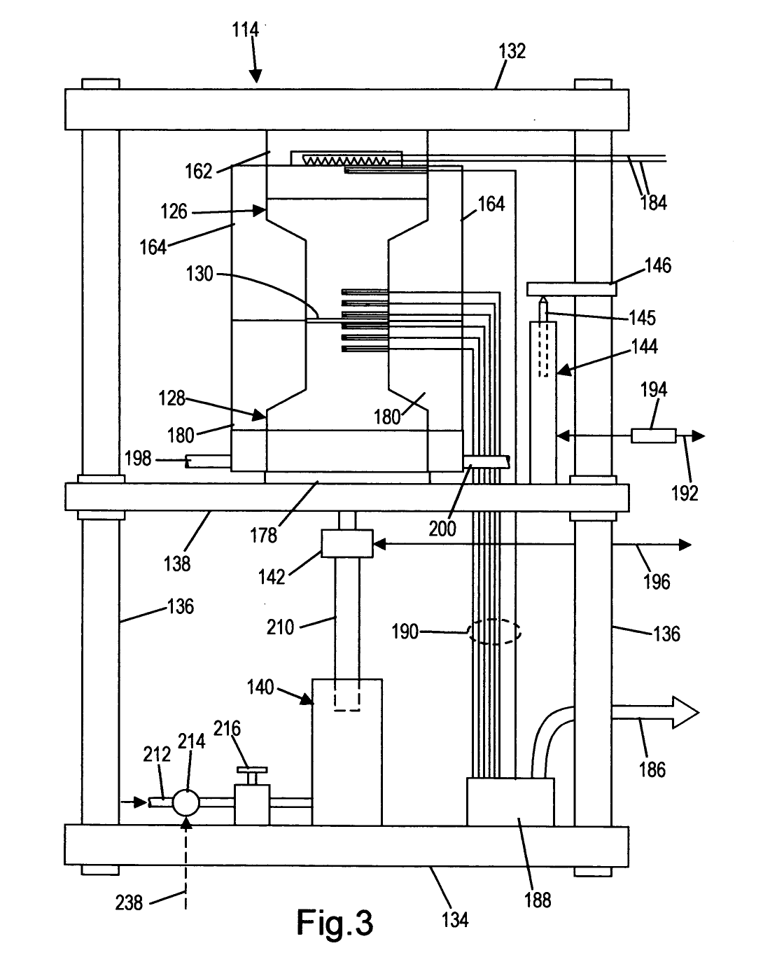

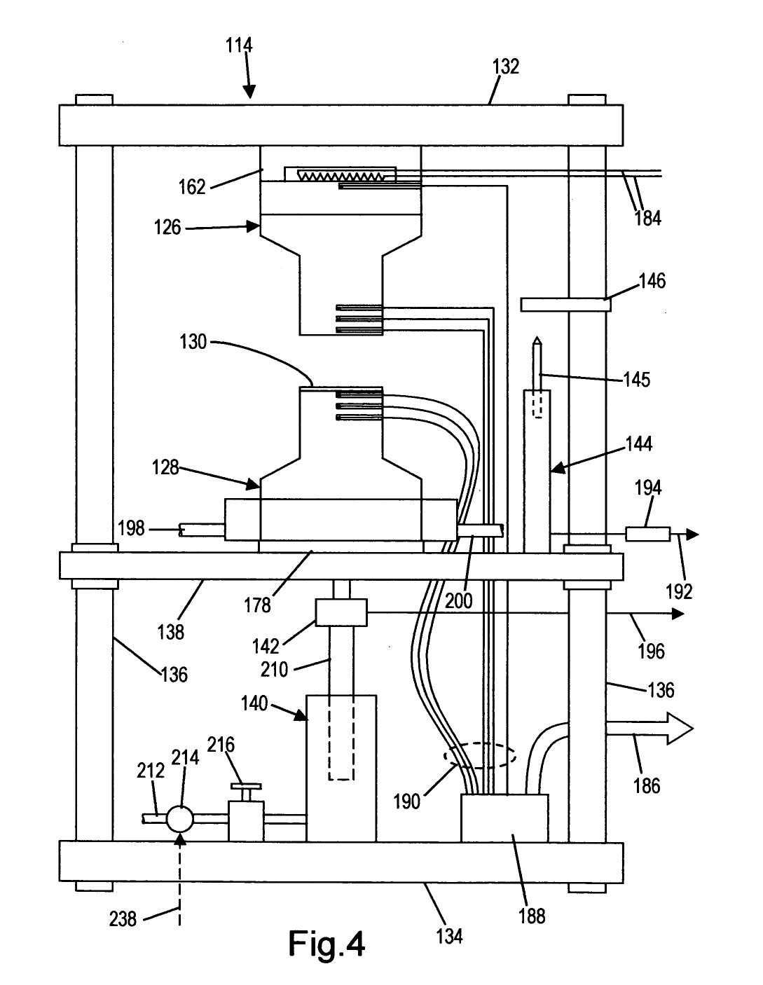

The thermal interface material characterization system 112 generally includes a test apparatus 114, a control system 116, a data acquisition unit 118, a workstation 120, a water circulator 122 and a compressed air source, or air pressure regulator, 124, as shown in the embodiment in FIG. 2. According to this embodiment, the test apparatus 114, as shown enlarged in FIGS. 3 and 4, generally includes hot and cold thermal head assemblies 126 and 128 between which a test, or candidate, TIM 130 is placed for testing. This embodiment of the test apparatus 114 further generally includes a stationary upper plate 132, a stationary lower plate 134, guide rods 136, a movable middle plate 138, a pneumatic jack or air piston 140, a load cell or force gauge 142 and an LVDT (Linear Variable Differential Transformer) transducer 144.

The upper plate 132 and the lower plate 134 are connected to and separated by the guide rods 136. The middle plate 138 moves up and down along the guide rods 136. The pneumatic jack 140 raises and lowers the middle plate 138. The hot thermal head assembly 126 is mounted to the upper plate 132 and is, thus, fixed in position. The cold thermal head assembly 128 is mounted on the middle plate 138 and, thus, moves up and down with the middle plate 138 as illustrated by the two positions shown in FIGS. 3 and 4. The plates 132, 134 and 138 and the guide rods 136 maintain the thermal head assemblies 126 and 128 in proper alignment.

Other embodiments may move the thermal head assemblies 126 and 128 relative to each other in other appropriate manners and with other appropriate equipment. For instance, the hot thermal head assembly 126 may be movable instead of, or in addition to, the cold thermal head assembly 128. Motion may be activated by an appropriate device other than a pneumatic jack, such as a hydraulic system of other appropriate mechanical motion apparatus. Alignment of the thermal head assemblies 126 and 128 may be maintained by an appropriate apparatus or set of devices other than the specific mechanical method illustrated by the plates 132, 134 and 138 and the guide rods 136.

The load cell 142 (or other appropriate device for generating force or load data) generates load data indicating the force applied by the pneumatic jack 140 at any position thereof. The force and/or pressure applied to the test TIM 130 can be calculated from the load data.

The LVDT transducer 144 is mounted on the middle plate 138 to move up and down with the cold thermal head assembly 128. The LVDT transducer 144 includes a pin 145 which, when in a lowered position (FIG. 4), fully protrudes out of the LVDT transducer 144, but which, when in a raised position (FIG. 3), engages a bracket 146 that is fixed to one of the guide rods 136 and that pushes the pin 145 down. The LVDT transducer 144, therefore, generates linear displacement data when in the raised position with and without the test TIM 130, thereby indicating the thickness of the test TIM 130. In alternative embodiments, the thickness of the test TIM 130 may be determined by other appropriate equipment and methods. For example, an optical lens measurement apparatus may be used, so the user looks at the interface gap through the lens and measures the thickness of the test TIM 130 optically. This measurement is a direct visual measurement unaffected by temperature that may cause other components, such as the thermal head assemblies 126 and 128 to expand or contract. The user may input the thickness data into the workstation.

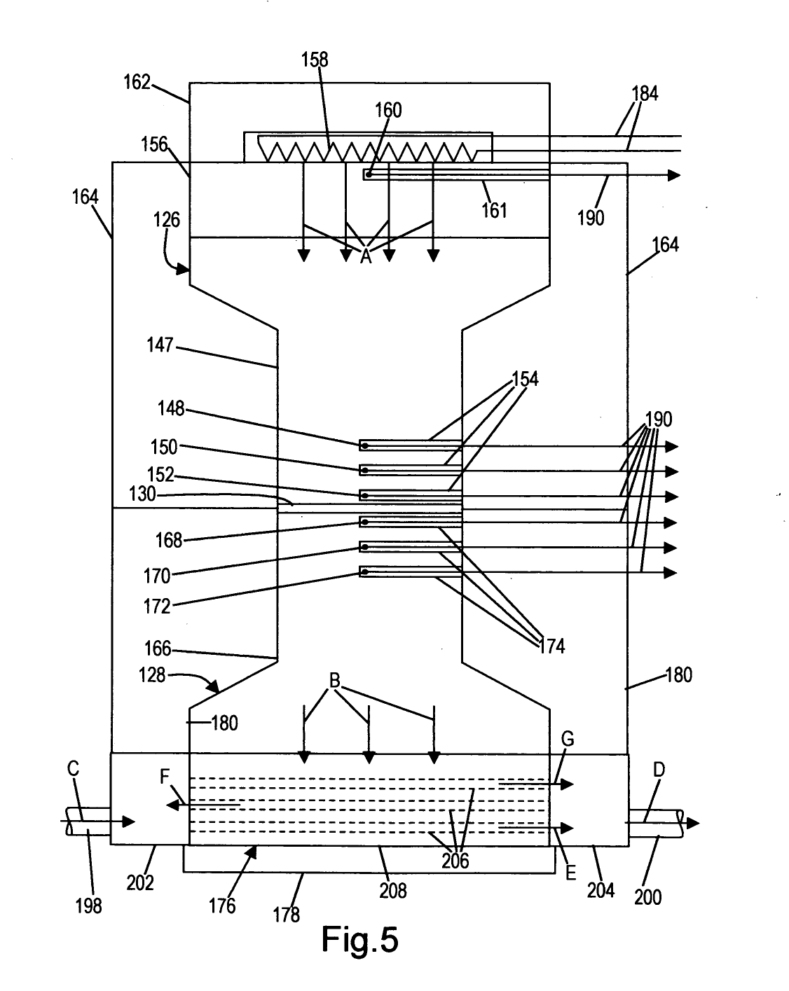

The hot thermal head assembly 126, as shown further enlarged in FIG. 5, generally includes a hot thermal head 147 with thermocouples 148,150 and 152 embedded therein through small drilled holes 154. In a particular embodiment, the hot thermal head 147 is made of a relatively low thermal resistance (high thermal conductance) material, such as aluminum, etc. Additionally, in a particular embodiment, the thermocouples 148, 150 and 152 are spaced a specific distance (e.g. about 0.5 inches) apart, with the lowest thermocouple 152 being positioned as close to the test surface of the hot thermal head 147 as possible without making the thickness of the test surface at the lowest hole 154 too thin. The test surface of the hot thermal head 147 simulates the roughness, curvature and any other relevant characteristics, or surface conditions, of the IC package 102 (FIG. 1).

The hot thermal head assembly 126 further generally includes a heater block 156 and a heater 158 (e.g. a foil heater, etc.). The heater 158 rests on top of the heater block 156 and transfers heat thereto when powered up. The heater block 156 is attached to the hot thermal head 147, e.g. by bolts or other removable means, so the hot thermal head 147 can be removed from the hot thermal head assembly 126 for service or replacement. A thermocouple 160 is embedded in the heater block 156 through a hole 161 as close to the top surface thereof as is practical to sense the temperature of the heater 158. Additionally, a top insulation 162 surrounds the heater block 156 and the heater 158 between the hot thermal head assembly 126 and the upper plate 132 of the test apparatus 114. Upper insulation jackets 164 surround the hot thermal head 147 and the heater block 156. The top insulation 162 ensures that the heat flows primarily in the direction of arrows A from the heater 158 through the heater block 156 and into the hot thermal head 147, rather than into the upper plate 132. The upper insulation jackets 164 ensure that little heat is lost to the ambient air surrounding the hot thermal head assembly 126.

The cold thermal head assembly 128 generally includes a cold thermal head 166 with thermocouples 168, 170 and 172 embedded therein through small drilled holes 174. In a particular embodiment, the cold thermal head 166 is geometrically similar, if not identical, to the hot thermal head 147. Such similarity, or identity, allows any such thermal head to be used as either the hot or the cold thermal head, as the situation may require. Additionally, fabrication of several such thermal heads may have a better economy of scale if both the hot and cold thermal heads are similar. In a particular embodiment, the cold thermal head 166 is made of a relatively low thermal resistance (high thermal conductance) material, such as aluminum, etc. Additionally, in a particular embodiment, the thermocouples 168, 170 and 172 are spaced a specific distance (e.g. about 0.5 inches) apart, with the highest thermocouple 168 being positioned as close to the test surface of the cold thermal head 166 as possible without making the thickness of the test surface at the highest hole 174 too thin. The test surface of the cold thermal head 166 simulates the roughness, curvature and any other relevant characteristics, or surface conditions, of the heat sink 108 (FIG. 1).

The cold thermal head assembly 128 further generally includes a cooling plate 176. The cold thermal head 166 is attached to the cooling plate 176, e.g. by bolts or other removable means, so the cold thermal head 166 can be removed from the cooling plate 176 for service or replacement. A bottom insulation 178 thermally isolates the cooling plate 176 from the middle plate 138 of the test apparatus 114. Lower insulation jackets 180 surround the cold thermal head 166. The cooling plate 176 is cooled, as described below, so the heat that passes from the hot thermal head 147 through the test TIM 130 and into the cold thermal head 166 further flows primarily in the direction of arrows B through the cold thermal head 166 into the cooling plate 176. The bottom insulation 178 ensures that little heat from the middle plate 138 is transferred into the cooling plate 176 so as not to degrade the heat sinking capability of the cooling plate 176. Additionally, the lower insulation jackets 180 ensure that little heat in the cold thermal head 166 is lost to the ambient air surrounding the cold thermal head assembly 128.

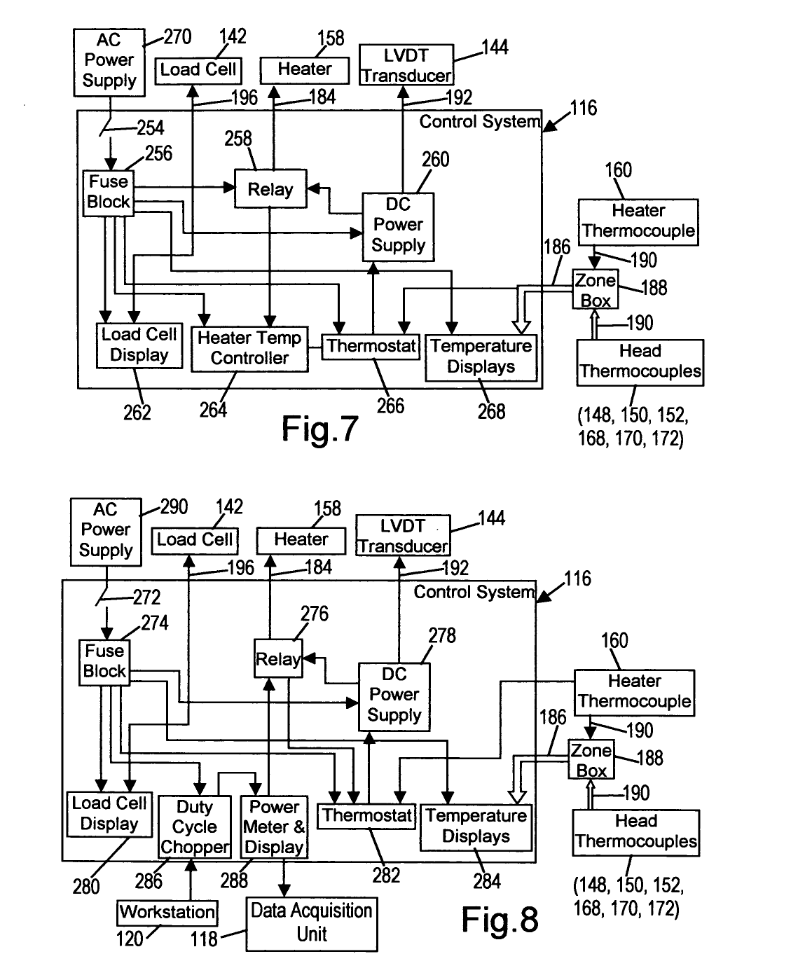

The control system 116 (FIG. 2) may be any appropriate electrical/electronic apparatus for generally performing the power and control functions described herein. An exemplary embodiment of the control system 116 will be described in more detail below with respect to FIGS. 7 and 8. Among other components, the control system 116 generally includes user controls 182 by which a user can adjust, or control, the operation of various components of the test apparatus 114. The control system 116 is electrically connected to provide power through wires 184 to the heater 158 in the heater block 156 of the hot thermal head assembly 126. The control system 116 is also electrically connected to receive temperature signals from the thermocouples 148, 150, 152, 160, 168, 170 and 172 through wires 186 (e.g. a ribbon cable) connected to a zone box 188 located on the lower plate 134 of the test apparatus 114 and then through thermocouple wires 190. The zone box 188 thermally isolates the thermocouples 148, 150, 152, 160, 168, 170 and 172 from the control system 116. The control system 116 is electrically connected to the LVDT transducer 144 through a portion of wires 192 that carry power signals and through a signal amplifier 194. The control system 116 is further electrically connected to the load cell 142 through wires 196 that carry power signals and return signals. With these connections, the control system 116 generally provides power to the various components of the test apparatus 114 and/or receives feedback/signals from some of the various components.

The water circulator 122 (FIG. 2) may be any appropriate apparatus for maintaining the cooling plate 176 at a cooled temperature. In the embodiment shown, the water circulator 122 cools water and circulates it to the cooling plate 176. Alternative embodiments, however, may include another type of cooling device within or in conjunction with the cooling plate 176. The water circulator 122 is connected to the cooling plate 176 of the cold thermal head assembly 128 of the test apparatus 114 by water supply and return lines 198 and 200. Water flows from the water circulator 122 through the water supply line 198 to a re-circulator portion, or manifold, 202 of the cooling plate 176 (arrow C). Water flows back to the water circulator 122 through the water return line 200 from another re-circulator portion, or manifold, 204 of the cooling plate 176 (arrow D). The recirculators 202 and 204 pass the water back and forth through several water holes 206 within a midsection 208 of the cooling plate 176 (arrows E, F and G). The water circulator 122 cools the returned water back down and pumps it back to the cooling plate 176. In this manner, the water maintains the cooling plate 176 at a desired temperature.

The compressed air source 124 (FIG. 2), in the embodiment shown, may be any appropriate apparatus (e.g. a portable air compressor, etc.) for supplying air pressure to the pneumatic jack 140 in order to operate a piston 210 (FIGS. 3 and 4) to raise and lower the middle plate 138 of the test apparatus 114 and, thus, to apply pressure to the test TIM 130 between the thermal head assemblies 126 and 128. In an alternative embodiment, however, any other appropriate device or devices (in place of the pneumatic jack 140 and the compressed air source 124) may be used to move the thermal head assemblies 126 and 128 together and to apply pressure to the test TIM 130. In the illustrated embodiment, the compressed air source 124 is connected to the pneumatic jack 140 by an air tube 212. A pressure regulator 214 and a shut-off valve 216 are interposed along the air tube 212 between the compressed air source 124 and the pneumatic jack 140. The pressure regulator 214 controls the air pressure to the pneumatic jack 140. The shut-off valve 216 stops the airflow at a fixed pressure once the air pressure has been set to a desired level. The shut-off valve 216 is also used as a safety stop to keep the piston 210 and the middle plate 138 at a fixed position when the test apparatus 114 is not being used. The load cell 142 (FIGS. 3 and 4) senses the force applied by the pneumatic jack 140 to the middle plate 138, which, along with the surface area of the thermal head assemblies 126 and 128 at the test TIM 130, enables the determination of the pressure on the test TIM 130. Therefore, once the pressure on the test TIM 130 reaches a desired test pressure by operation of the compressed air source 124 and the pressure regulator 214, the shut-off valve 216 may be closed to maintain the pressure. Thus, the pneumatic jack 140 operates to maintain a constant pressure on the test TIM 130 even if the thickness of the test TIM 130 and the distance between the thermal head assemblies 126 and 128 changes slightly.

The data acquisition unit 118 (FIG. 2) may be any appropriate device for receiving raw data or sensor signals of the type described herein and converting them to digital data where needed. For example, in a particular embodiment, the data -acquisition unit 118 is an Agilent 34970A machine available from Agilent Technologies, Inc. The data acquisition unit 118 collects the raw data or sensor signals from the thermocouples 148, 150, 152, 160, 168, 170 and 172 through the wires 186. The data acquisition unit 118 also collects the raw data or sensor signals from the LVDT transducer 144 through a portion of the wires 192 that carry return signals. The data acquisition unit 118 further collects the raw data or sensor signals from the load cell 142 through a portion of the wires 196 that carry returns signals. Alternatively, the data acquisition unit 118 collects some or all of the raw data or sensor signals routed through the control system 116 via lines 218. The data acquisition unit 118 transfers the digital data to the workstation 120 through lines 220, e.g. a bus, such as a GPIB (General Purpose Interface Bus) bus.

The workstation 120 (FIG. 2) may be any appropriate apparatus for receiving and analyzing the data generated by the test apparatus 114 through the data acquisition unit 118. In a particular embodiment, for example, the workstation 120 includes one or more general purpose computers or personal computers running appropriate software. Thus, the workstation 120 generally has a user interface 222, a data collection program 224, a data analysis program 226, a database builder program 228 and a database 230. In a particular embodiment, the workstation 120 runs National Instruments LabVIEW (TM) software available from National Instruments Corporation. The LabVIEW software is a graphical programming language that provides functions and tools for data analysis, report generation, data acquisition, signal analysis, instrument control and file input/output. In this embodiment, therefore, the LabVIEW software serves the functions of the user interface 222, the data collection program 224, the data analysis program 226 and the database builder program 228. Using the user interface 222, the user controls the workstation 120 to set up and control the testing of the test TIM 130 (FIGS. 3, 4 and 5), the collecting of the data, the analyzing of the data and the building of the database 230.

The user inputs desired parameters and information into the user interface 222 for the current test, such as the name of the test TIM 130, the surface condition of the thermal heads 147 and 166 (FIG. 5), the test area of the thermal heads 147 and 166, a set of test pressures or a pressure table (specific pressure values for running tests), a desired temperature for the surface of the cold thermal head 166, a desired heat flux through the test TIM 130 and any other desired information. With this information, the workstation 120 determines the settings for each of the controllable components of the thermal interface material characterization system 112. For example, using the desired temperature for the surface of the cold thermal head 166 and the desired heat flux through the test TIM 130, the workstation 120 estimates the proper settings for the heater 158 (e.g. heater temperature or power dissipation) in the heater block 156 of the hot thermal head assembly 126 and for the cooling water (e.g. water temperature) in the water circulator 122. Also, using the test pressure and the area of the thermal heads 147 and 166, the workstation 120 estimates the necessary load to be applied by the pneumatic jack 140 to the middle plate 138.

According to one particular embodiment, the workstation 120 controls the operation of some of the other components of the thermal interface material characterization system 112, such as the control system 116, the water circulator 122, the compressed air source 124 and any other appropriate components. For example, under this embodiment, the workstation 120 may be connected to the control system 116, the water circulator 122, the compressed air source 124 and/or the pressure regulator 214 through lines 232, 234, 236 and 238, respectively. After the settings for these components are determined by the workstation 120, the workstation 120 sends signals through the lines 232, 234, 236 and 238 to set these components to the desired or initial settings.

According to another particular embodiment, however, the workstation 120 does not directly control the operation of some or all of the controllable components of the thermal interface material characterization system 112. In this case, the workstation 120 prompts the user to manually set the desired or initial settings for these controllable components as determined by the workstation 120, or the user watches the data from some of the sensors and adjusts some of the controllable components accordingly. Additionally, some of the components of the test apparatus 114 (e.g. the shut-off valve 216, etc.) may be manually operated even if the workstation 120 directly controls some of the other components in order for the user to ensure proper operation of the thermal interface material characterization system 112.

The workstation 120 receives the generated data from the data acquisition unit 118 through the lines 220. With some of this data, the workstation 120 determines (e.g. by the data analysis program 226) whether the settings of the controllable components have resulted in the test parameters inputted by the user being satisfied, such as the desired test pressure, the desired temperature for the test surface of the cold thermal head 166 and the desired heat flux through the test TIM 130. If any of the test parameters have not been satisfied, then the workstation 120 may re-estimate the settings for any of the controllable components and reset the components, as discussed above, until the test parameters have been properly satisfied.

For example, the load data generated from the load cell 142 when the middle plate 138 and the cold thermal head assembly 128 are in the raised position (FIG. 3) minus the load data generated from the load cell 142 when the middle plate 138 and the cold thermal head assembly 128 are in the lowered position (FIG. 4) divided by the test area of the thermal heads 147 and 166 determines the actual pressure applied to the test TIM 130. If the actual pressure does not sufficiently match the desired pressure, then the workstation resets the compressed air source 124 and/or the pressure regulator 214 or the user manually adjusts the pressure regulator 214 until the actual pressure matches or is sufficiently close to the desired pressure. Additionally, the temperature data generated from the thermocouple 168 (FIG. 5) immediately below the test surface of the cold thermal head 166 reflects the actual temperature for the test surface of the cold thermal head 166. If the actual temperature for the test surface of the cold thermal head 166 does not match the desired temperature, then the workstation 120 re-estimates the proper setting for the cooling water and either the workstation 120 or the user resets the water circulator 122. Furthermore, the actual heat flux through the hot thermal head 147 (which will be almost the same as the actual heat flux through the test TIM 130) can be calculated directly from Fourier's equation for one-dimensional heat conduction using a known thermal conductivity of the material of the hot thermal head 147, the temperature data generated from any two thermocouples therein (e.g. 148 and 152) and the distance between those two thermocouples. If the actual heat flux does not sufficiently match the desired heat flux, then the workstation 120 re-estimates the temperature for, or power applied to, the heater 158 and either the workstation 120 or the user resets the temperature or applied power at the control system 116.

Since each of the values that go into the calculation of the heat flux is known, the heat flux is directly determined from the generated temperature data, rather than relying on estimates of parameters, calibrations of equipment or comparisons with test results for known TIMs. Therefore, the accuracy, precision and reliability of the tests are greater than in the prior art described in the background.

When all of the desired parameters for the test have been satisfied and steady state conditions have been achieved, the workstation 120 reads the final generated test data. The steady state conditions, or “convergence,” may have occurred when the temperature data and actual heat flux are no longer changing, or none of the temperature data changes faster than a given amount in a given time (e.g. about 0.5 degrees C. per minute) and the heat flux changes less than a given percentage in a given time (e.g. about 5% per minute).

When the workstation 120 has the final generated test data, the data analysis program 226 calculates the relevant characteristics of the test TIM 130, such as the thermal resistance, equivalent thermal conductivity, etc. The database builder program 228 stores in the database 230 these relevant characteristics along with the identifying information inputted by the user. The database 230 can then be referenced whenever a TIM 110 (FIG. 1) is needed for a new IC package 102 and heat sink 108 combination in order to quickly select the preferred TIM 110 during the development of a new product (e.g. the computer system 100).

The thermal resistance (R) of the test TIM 130 is calculated from the temperature difference across the test TIM 130 (temperature data from thermocouple 152 minus temperature data from thermocouple 168) divided by the heat flux through the test TIM 130 (calculated as described above). Since the interface gap (or TIM thickness) is known from LVDT transducer data, the equivalent thermal conductivity for the test TIM 130 can be calculated from the thickness of the test TIM 130 divided by the thermal resistance thereof. The equivalent thermal conductivity is generally a hypothetical value, so it may be preferable to use it only for reference. However, if the test TIM 130 could be “fused in” the gap between the thermal heads 147 and 166 in such a way that there is no temperature drop across the bonds between the test TIM 130 and either of the thermal heads 147 and 166, the thermal conductivity of the test TIM 130 would be represented by the “equivalent thermal conductivity” quantity.

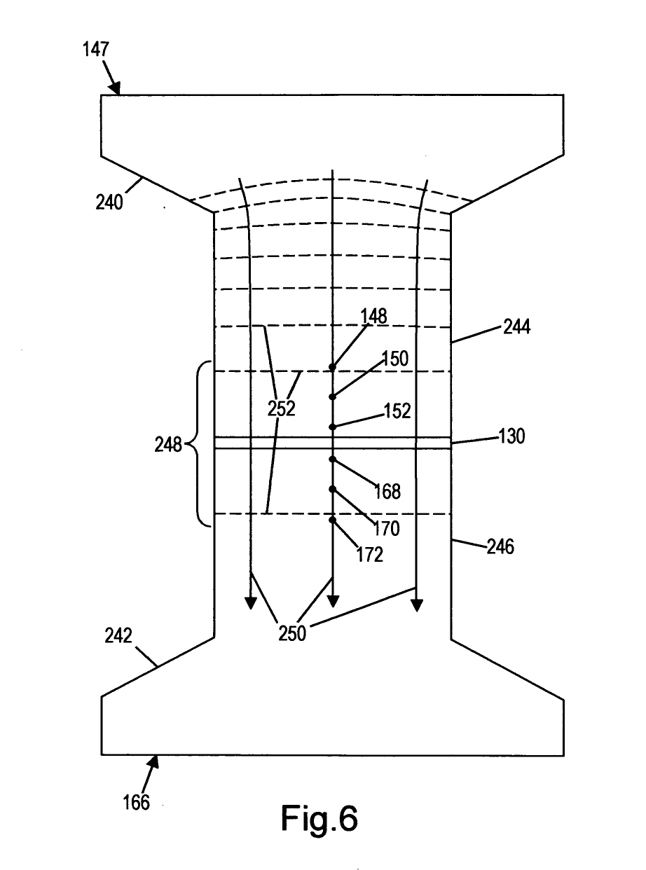

One dimensional heat flow, which enables the use of Fourier's law of conduction as described above, is ensured by the geometry of the thermal heads 147 and 166, as shown in FIG. 6, and the insulation jackets 164 and 180 (FIGS. 3, 4 and 5) in this embodiment. The thermal heads 147 and 166 are tapered at their bases 240 and 242, respectively, and have straight sections 244 and 246, respectively, near the test TIM 130. The shape of the bases 240 and 242 ensure that when the heat reaches a region 248 of the straight sections 244 and 246 where the thermocouples 148,150, 152,168, 170 and 172 are located, the heat is flowing in a single direction (one dimensional heat flow) as indicated by heat flow lines 250 and temperature isometric lines 252. Thus, temperature measurements taken within the region 248 may be used to calculate the heat flux using Fourier's law above. Thus, the thermocouples 148-152 and the thermocouples 168-172 serve as upper and lower “heat flux meter bars,” respectively.

The heat flux through the hot thermal head 147 should equal the heat flux through the cold thermal head 166, unless the test TIM 130 is undergoing a phase change (i.e. melting or solidifying). Therefore, the heat flux may be calculated for the cold thermal head 166 in order to confirm the heat flux calculated for the hot thermal head 147. If the two heat flux calculations are converging but are not equal or sufficiently close, then steady state, or convergence, has not been reached.

Theoretically, in perfectly efficient thermal heads, 100% of the heat flows straight through the hot thermal head, crosses the interface and continues to flow straight through the cold thermal head. In practice, however, there are some spurious residual heat losses to ambient air from side surfaces due to natural convection and radiation. The insulation jackets 164 and 180 minimize the spurious residual heat losses. However, due to the heat flux meter bars (thermocouples 148-152 and thermocouples 168-172), the spurious residual heat losses do not significantly affect measurement accuracy or calculations in some cases. If heat is lost by natural convection, the amount of heat flux through the thermal heads 147 and 166 is reduced. This effect is self-compensating, since the workstation 120 (FIG. 2) and the control system 116 automatically compensate for a reduced heat flux by increasing the temperature of, or power supplied to, the heater 158 (FIG. 5). Thus, particularly for test TIMs with low thermal resistance, the heat flux calculated using the heat flux meter bar temperature readings is sufficiently accurate, regardless of spurious residual heat losses. In fact, for most test TIMs with low thermal resistance, it is not necessary to use the insulation jackets 164 and 180, so the insulation jackets 164 and 180 are optional in these cases. For relatively high thermal resistance test TIMs, however, using the insulation jackets 164 and 180 may slightly improve the overall accuracy of the test. A significant advantage of using the insulation jackets 164 and 180, though, is heater energy conservation.

The thermal heads 147 and 166, according to a particular embodiment, can be removed from the thermal head assemblies 126 and 128 for service, repair or replacement. The test surfaces, for instance, may wear out or become scratched or otherwise damaged when the test TIM 130 has to be removed from the thermal heads 147 and/or 166 by scraping. Thus, the removability of the thermal heads 147 and 166 enables quick replacement of worn out thermal heads. Additionally, other hot and cold thermal heads 147 and 166 can be placed in the thermal head assemblies 126 and 128 to simulate different test conditions. In other words, thermal heads 147 and 166 having different test surfaces with different curvatures (e.g. concave, convex or straight), different roughness and/or different surface areas may be used in different tests in order to properly simulate the physical characteristics of the IC package 102 (FIG. 1) and the heat sink 108. Additionally, each different hot and cold thermal head 147 and 166 has a set of the thermocouples 148-152 or 168-172 embedded therein. Therefore, it is not necessary to change the thermocouples or alter the thermal heads 147 and 166 when switching different thermal heads 147 and 166 into the thermal head assemblies 126 and 128 or preparing for a next test. Instead, manual test setup procedures only involve removal of any TIM from a previous test without a risk of damaging or altering the thermal heads 147 and 166 before placing the new test TIM 130 onto the thermal heads 147 and 166. Thus, the complex, time consuming and error prone manual assembly procedure described in the background does not occur in this embodiment. As a consequence, test results generally have higher repeatability and reliability factors.

According to an embodiment, the control system 116 generally includes a power switch 254, a fuse block 256, a relay 258, a DC power supply 260, a load cell display 262, a heater temperature controller 264, a thermostat 266 and temperature displays 268, as shown in FIG. 7. The power switch 254 turns on and off AC electrical power to the control system 116 from an external AC power supply 270. The AC power supply 270 has a GFI (Ground Fault Interrupt) circuit to prevent accidental shorting of the electrical components and prevent user exposure to potentially high voltages. The AC electrical power is supplied to the fuse block 256 when the power switch 254 is turned on. The fuse block 256 distributes the AC electrical power to the relay 258, the DC power supply 260, the load cell display 262, the heater temperature controller 264, the thermostat 266 and the temperature displays 268.

The load cell display 262 may be any appropriate device for supplying power (e.g. a DC voltage) to the load cell 142 and receiving the load data generated by the load cell 142. In a particular embodiment, the load cell display 262 is an Omega DP25B-S strain meter, or load cell reader, available from Omega Engineering, Inc. The load cell display 262 provides DC voltage (through the portion of the wires 196 that carry power signals) to the load cell 142 (e.g. about 10 volts, etc.). The load cell display 262 also reads (through the portion of the wires 196 that carry return signals) a raw sensor voltage generated from the load cell 142 (e.g. in mV) and converts the raw sensor voltage to a weight value (e.g. pounds, etc). The raw sensor voltage is also supplied to the data acquisition unit 118 (FIG. 2). The load cell display 262 displays the weight value for viewing on a small display. An initial weight value (a “rest” weight) of the middle plate 138 and the cold thermal head assembly 128 (FIGS. 3, 4 and 5) in a lowered position (e.g. as shown in FIG. 4) is subtracted from the displayed weight, i.e. the load cell display 262 is initially “zeroed-out.” In this manner, the load cell display 262 displays the net load applied to the test TIM 130 when the thermal heads 147 and 166 are pressed together.

The DC power supply 260 receives the AC electrical power and provides DC voltages (e.g. about 12 volts-24 volts) to a control side of the relay 258 and to the LVDT transducer 144. The DC voltage to the LVDT transducer 144 is supplied through the portion of the wires 192 that carry power signals. The return signals, or raw sensor signals, generated by the LVDT transducer 144 may be sent to the data acquisition unit 118.

The relay 258, the DC power supply 260, the heater temperature controller 264 and the thermostat 266 operate together to supply electrical power through the wires 184 to the heater 158 in the heater block 156 (FIG. 5) of the hot thermal head assembly 126. The DC voltage supplied from the DC power supply 260 is passed through the relay 258, the heater temperature controller 264 and the thermostat 266. When the heater temperature controller 264 and the thermostat 266 are turned on, as described below, the DC voltage passes through and turns on the relay 258. The relay 258, when turned on, supplies the AC electrical power received from the fuse block 256 through the wires 184 to the heater 158, which causes the heater 158 to heat up.

The heater temperature controller 264 may be any appropriate apparatus for controlling the temperature setting of the heater 158. In a particular embodiment, the heater temperature controller 264 is an Omega CNi3222 temperature controller available from Omega Engineering, Inc. In this embodiment, the desired test temperature for the heater 158 is set on the heater temperature controller 264. The heater temperature controller 264 receives the temperature signal generated by the heater thermocouple 160 within the heater block 156 (FIG. 5) of the hot thermal head assembly 126. If the temperature read from the heater thermocouple 160 is below the desired test temperature, the heater temperature controller 264 turns on (e.g. closes an internal switch). If the temperature read from the heater thermocouple 160 is greater than the desired test temperature, the heater temperature controller 264 turns off (e.g. opens the internal switch). In this manner, the heater temperature controller 264 “hunts” back and forth at the desired test temperature to maintain the heater 158 at the desired test temperature.

The thermostat 266 may be any appropriate apparatus for setting a maximum temperature for the heater 158. In a particular embodiment, the thermostat 266 is an Omega CN355) temperature controller available from Omega Engineering, Inc. In this embodiment, the thermostat 266 is set to a maximum temperature above which it is desired that the heater 158 never be heated. This situation may occur if the heater temperature controller 264 fails to properly control the temperature of the heater 158, thereby allowing the heater 158 to overheat. The thermostat 266 receives the temperature signal generated by the heater thermocouple 160, and if the temperature is below the maximum temperature, the thermostat 266 turns on (e.g. closes an internal switch). If the temperature read from the heater thermocouple 160 is greater than the maximum temperature, the thermostat 266 turns off (e.g. opens the internal switch). In this manner, the thermostat 266 serves as a failsafe mechanism to prevent over-temperature run-away conditions.

The temperature displays 268 may be any appropriate apparatus for receiving the temperature data generated by the head thermocouples 148, 150, 152, 168, 170 and 172 within the thermal heads 147 and 166 (FIG. 5) of the thermal head assemblies 126 and 128 and displaying the temperature data to the user. In a particular embodiment, the temperature displays 268 are an Omega DP462 temperature reader/display available from Omega Engineering, Inc.

According to an alternative embodiment, the control system 116 generally includes a power switch 272, a fuse block 274, a relay 276, a DC power supply 278, a load cell display 280, a thermostat 282, temperature displays 284, a duty cycle chopper 286 and a power meter and display 288, as shown in FIG. 8. The power switch 272 turns on and off AC electrical power to the control system 116 from an external AC power supply 290. The AC electrical power is supplied to the fuse block 274 when the power switch 272 is turned on. The fuse block 274 distributes the AC electrical power to the DC power supply 278, the load cell display 280, the thermostat 282, the temperature displays 284 and the duty cycle chopper 286. The load cell display 280 may be similar to the load cell display 262 (FIG. 7) and has a similar function, as described above. Likewise, the DC power supply 278 may be similar to the DC power supply 260 (FIG. 7) and has a similar function, as described above. Additionally, the temperature displays 284 may be similar to the temperature displays 268 (FIG. 7) and has a similar function, as described above. The duty cycle chopper 286 may be any appropriate apparatus for regulating or controlling the electrical power that is supplied to the heater 158.

The duty cycle chopper 286 sets the electrical power that is supplied to the heater 158. The heat flux through the thermal heads 147 and 166 and the test TIM 130 is usually directly related to the power consumed by the heater 158. In particular, the heat flux is usually a percentage of the heater power. Thus, the ratio of the actual heat flux to the desired heat flux is usually close to the ratio of the actual heater power to the needed heater power. With this relationship, the heater power can be quickly adjusted to result in the desired heat flux passing through the test TIM 130. Therefore, the number of adjustments, or iterations, to the heater power required to achieve the desired test conditions are minimized and convergence to steady state conditions may happen faster than with the embodiment illustrated by FIG. 7.

The duty cycle chopper 286 receives the AC electrical power from the fuse block 274 and generates an AC signal with a specific duty cycle (e.g. 0-100%), thereby controlling the electrical power of the AC signal. The AC signal is passed through the power meter and display 288 to detect and display the electrical power of the AC signal. The AC signal is then passed to the relay 276 and supplied to the heater 158 when the relay 276 is on. The relay 276, the DC power supply 278 and the thermostat 282 operate together to supply the AC signal through the wires 184 to the heater 158. The DC voltage supplied from the DC power supply 278 is passed through the relay 276 and the thermostat 282. The thermostat 282 may be similar to the thermostat 266 (FIG. 7) and has a similar function, as described above. When the thermostat 282 is turned on, the DC voltage passes through and turns on the relay 276. The relay 276, when turned on, supplies the AC signal generated by the duty cycle chopper 286 through the wires 184 to the heater 158, which causes the heater 158 to generate heat according to the power level of the AC signal.

According to an embodiment, the duty cycle chopper 286 is controlled by the workstation 120, so the workstation 120 is connected to, and supplies control signals to, the duty cycle chopper 286. To provide feedback to the workstation 120, the data acquisition unit 118 is connected to the power meter and display 288. The power meter and display 288 sends a signal to the data acquisition unit 118 indicating the power level of the AC signal generated by the duty cycle chopper 286. Thus, the data acquisition unit 118 passes power level data to the workstation 120, so the workstation 120 can set and reset the duty cycle for the duty cycle chopper 286 as needed to converge to the desired heat flux.

According to an alternative embodiment, the duty cycle chopper 286 is controlled by the user, as prompted by the workstation 120. Thus, the workstation 120 indicates to the user the desired power level to be supplied to the heater 158. The user sets the duty cycle chopper 286 using the feedback from the power meter and display 288.

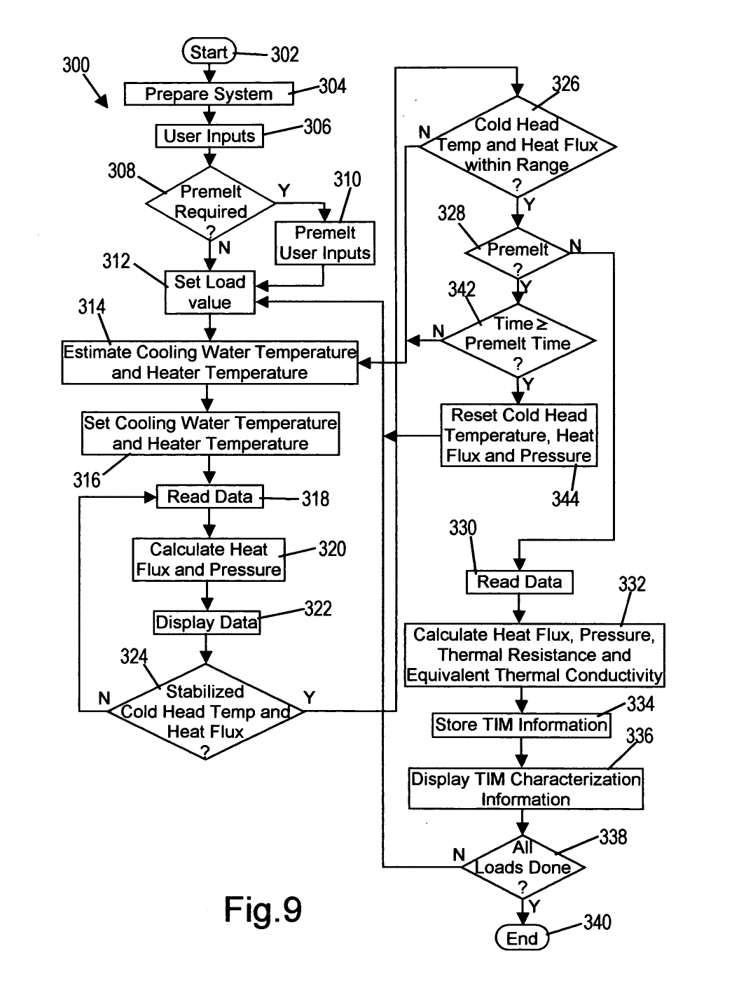

An exemplary procedure 300 for performing a test of a TIM 130 (FIGS. 3, 4 and 5), according to an embodiment of the present invention, is shown in FIG. 9. Upon starting (at 302), the user prepares (at 304) the thermal interface material characterization system 112 (FIG. 2), including selecting the thermal heads 147 and 166 (FIG. 5), installing the thermal heads 147 and 166 into the thermal head assemblies 126 and 128, placing the test TIM 130 between the thermal heads 147 and 166, setting the thermostat 266, placing insulation jackets 164 and 180, “zeroing-out” the load cell display 262 and powering up the control system 116, the water circulator 122, the compressed air source 124, the data acquisition unit 118 and the workstation 120. At the prompting of the workstation 120, the user enters (at 306) the user inputs into the user interface 222, including the name of the test TIM 130, the surface conditions of the thermal heads 147 and 166, the area of the thermal heads 147 and 166, the desired test pressure(s), the temperature for the test surface of the cold thermal head 166, the heat flux, etc. If the test TIM 130 may undergo phase change during the testing, then a premelt procedure may need to be performed. Therefore, if a premelt procedure is required, as determined at 308, the user enters (at 310) the premelt user inputs to be used during the premelt procedure, including the pressure to be applied to the test TIM 130, the temperature of the cold thermal head 166, the heat flux and the time duration for the premelt procedure.

The workstation 120 sets, or prompts the user to set, (at 312) the load value for the pneumatic jack 140 based on the desired test pressure and the area of the thermal heads 147 and 166. Also, if the thermal heads 147 and 166 are not already in the position shown in FIG. 3, the cold thermal head 166 is raised to this position at 312. If a premelt procedure is being performed, then the desired test pressure is the pressure entered at 310, otherwise the desired test pressure is the pressure (or first pressure if more than one is to be used) entered at 306. Using the feedback from the load cell 142 and the area of the thermal heads 147 and 166, the workstation 120 iterates through calculating the actual pressure, determining whether the actual pressure is close enough to the desired pressure and resetting (or prompting the user to set) the load value until the actual pressure is sufficiently close to the desired pressure (e.g. within about 5%).

The workstation 120 estimates (at 314) the temperature for the cooling water in the water circulator 122 and the temperature for the heater 158 based on the desired temperature for the cold thermal head 166, the desired heat flux through the test TIM 130 and the known thermal resistance of the thermal heads 147 and 166. (Since the temperature of the heater 158 is being used at this point, it is assumed for this procedure 300 that the embodiment of the control system 116 is the embodiment shown in FIG. 7.) If a premelt procedure is being performed, then the desired temperature for the cold thermal head 166 and the desired heat flux through the test TIM 130 are those values entered at 310, otherwise the values entered at 306 are used. The cooling water temperature and heater temperature are then set (at 316) by the workstation 120, or by the user according to instructions from the workstation 120. For the heater temperature, the feedback from the thermocouple 160 is used to determine when the temperature of the heater 158 as reached the proper setting.

The data generated by the thermocouples 148, 150, 152, 160, 168, 170 and 172 is read (at 318). The heat flux and the pressure are calculated (at 320) as described above. The relevant data, measured and calculated, is displayed (at 322), so the user can monitor the progress of the test. If the temperature of the cold thermal head 166 and the heat flux have not stabilized, as determined at 324, then 318, 320 and 322 (reading, calculating and displaying the data) are iteratively repeated until stabilization (i.e. steady state, or convergence) has occurred. Once the temperature of the cold thermal head 166 and the heat flux have stabilized, as determined at 324, it is determined (at 326) whether the temperature of the cold thermal head 166 and the heat flux are within an acceptable range (e.g. temperature within about 0.2 degrees C. and heat flux within about 2%) of the desired values that were entered at 306 (or at 310, for a premelt procedure). If not, then 314, 316, 318, 320, 322 and 324 are repeated, i.e. re-estimating (at 314) and resetting (at 316) the temperature for the cooling water and the temperature for the heater 158 and then waiting (at 318, 320, 322 and 324) for steady state conditions to occur.

Once the temperature of the cold thermal head 166 and the heat flux have stabilized within an acceptable range, as determined at 326, and if not currently performing a premelt procedure (as determined at 328), then the final data is read (at 330). The heat flux, the pressure and the relevant thermal characteristics of the test TIM 130 (such as the thermal resistance and the equivalent thermal conductivity) are calculated (at 332). Information (entered, measured and/or calculated) for the test TIM 130 is stored (at 334) in the database 230. The characterization information for the test TIM 130 may then be displayed (at 336) to the user. If the test has been done for all of the loads for all of the test pressures, as determined at 338, then the procedure 300 ends at 340. Otherwise, the procedure 300 returns to 312 to set the next load value for the next test pressure and the test is repeated for this test pressure.

If it is determined at 328 that a premelt procedure is being performed, then it is determined at 342 whether the time for the premelt procedure (entered at 310) has expired. If not, then the procedure 300 must wait for the premelt procedure to finish. In order to ensure that none of the data changes (e.g. due to a phase change of the test TIM 130), the procedure 300 returns to 314 and repeats as above. On the other hand, if the the time for the premelt procedure has expired, as determined at 342, then the desired temperature for the cold thermal head 166 and the heat flux are reset (at 344) to those values entered at 306, and the procedure 300 returns to 312 to proceed with the testing of the test TIM 130, as described above.

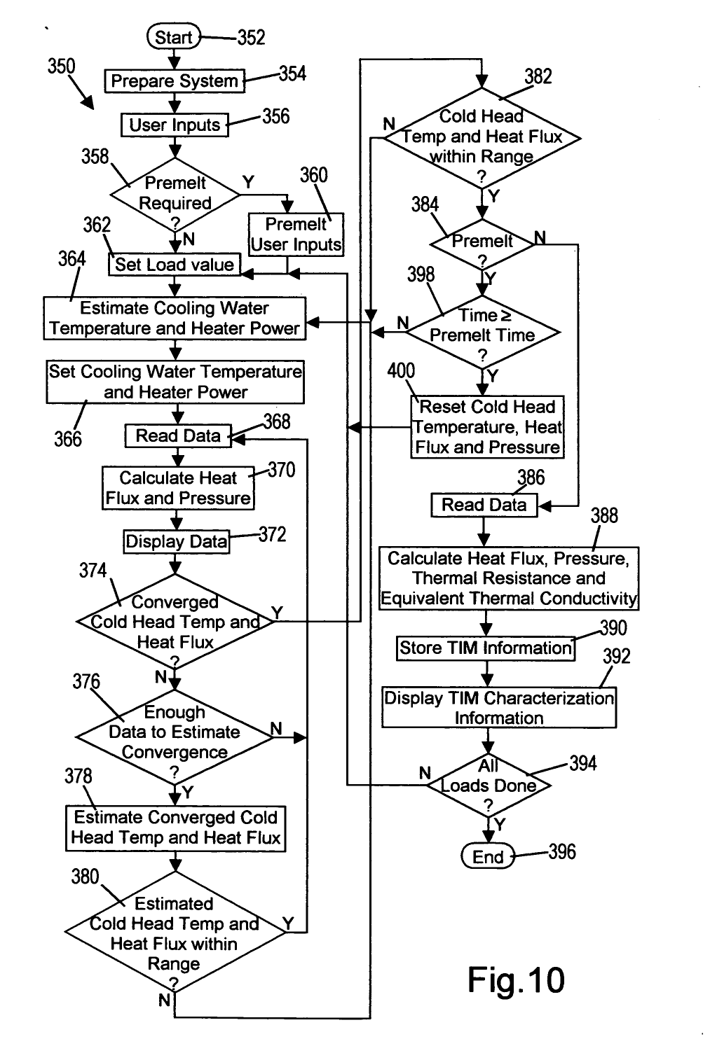

An alternative exemplary procedure 350 for performing a test of a TIM 130 (FIGS. 3, 4 and 5), according to an alternative embodiment of the present invention, is shown in FIG. 10. Upon starting (at 352), the procedure 350 continues through 354, 356, 358, 360 and 362 similarly to 304, 306, 308, 310 and 312, respectively, as described above.

The workstation 120 estimates (at 364) the temperature for the cooling water in the water circulator 122 and the power level for the heater 158 based on the desired temperature for the cold thermal head 166 and the desired heat flux through the test TIM 130. (Since the power level of the heater 158 is being used at this point, it is assumed for this procedure 350 that the embodiment of the control system 116 is the embodiment shown in FIG. 8.) If a premelt procedure is being performed, then the desired temperature for the cold thermal head 166 and the desired heat flux through the test TIM 130 are those values entered at 360, otherwise the values entered at 356 are used. The cooling water temperature and heater power are then set (at 366) by the workstation 120, or by the user according to instructions from the workstation 120, as described above.

The procedure 350 continues through 368, 370 and 372 similarly to 318, 320 and 322, respectively, as described above. If the temperature of the cold thermal head 166 and the heat flux have not converged to steady state conditions, as determined at 374, then it is determined at 376 whether there are enough data points with which to estimate the eventual converged steady state temperature of the cold thermal head 166 and the heat flux. If not, then the procedure 350 returns to 368 to collect more data points. When there are enough data points, as determined at 376, with which to estimate the eventual converged steady state temperature of the cold thermal head 166 and the heat flux, the eventual converged steady state temperature of the cold thermal head 166 and the heat flux are estimated (at 378). According to an embodiment, the estimation involves performing a curve fit using the data points obtained so far and an exponential decay curve to extrapolate the eventual steady state values.

If the estimated eventual converged steady state temperature of the cold thermal head 166 and the heat flux are within an acceptable range, as determined at 380, then the procedure 350 returns to 368 to iteratively continue reading the data until steady state conditions actually occur, as determined at 374. On the other hand, if the estimated eventual converged steady state temperature of the cold thermal head 166 and the heat flux are not within an acceptable range, as determined at 380, then the procedure 350 returns to 364 to re-estimate the proper temperature for the cooling water and the proper power to be supplied to the heater 158. In this manner, before steady state convergence occurs, if it is determined that the eventual steady state conditions will not be within an acceptable range, the water circulator 122 and the heater 158 can be reset without having to wait for the actual steady state convergence, as in the procedure 300 (FIG. 9). Therefore, the estimation of the steady state conditions enables a more rapid test procedure.

Once the temperature of the cold thermal head 166 and the heat flux have converged to steady state conditions, as determined at 374, then it is determined at 382 whether the actual temperature of the cold thermal head 166 and the heat flux are within the acceptable range. If not, then the procedure 350 returns to 364 and continues as above. However, since the procedure 350 has been estimating the eventual temperature of the cold thermal head 166 and the heat flux, as described above, it is likely that the determination at 382 will almost always be positive, thereby usually preventing a return to 364 at this point. Upon determining at 382 that the actual temperature of the cold thermal head 166 and the heat flux are within the acceptable range, the procedure 350 continues through 384, 386, 388, 390, 392, 394, 396, 398 and 400 similarly to 328, 330, 332, 334, 336, 338, 340, 342 and 344, respectively, as described above.

We claim:

1. A thermal interface material characterization system comprising:
a first thermal head;
a second thermal head positioned in alignment with the first thermal head;
a thermal interface material disposed between the first and second thermal heads and through which heat flows from the first thermal head to the second thermal head;
a first plurality of thermal sensors disposed within the first thermal head and generating temperature data from a plurality of locations along an axis in a direction of heat flow through the first thermal head; and
a second plurality of thermal sensors disposed within the second thermal head and generating temperature data from a plurality of locations along an axis in a direction of heat flow through the second thermal head;
and wherein a thermal characteristic of the thermal interface material can be determined from the temperature data generated from the first and second plurality of thermal sensors.

2. A thermal interface material characterization system as defined in claim 1 wherein the first and second thermal heads are removable from the thermal interface material characterization system.

3. A thermal interface material characterization system as defined in claim 1 further comprising:
a load actuator operable to force the first and second thermal heads together to apply a pressure to the thermal interface material to simulate a condition in which it is desired to use the thermal interface material.

4. A thermal interface material characterization system as defined in claim 1 wherein:
at least a portion of the plurality of thermal sensors disposed within the first thermal head forms a meter bar to generate at least a portion of the temperature data from which the thermal characteristic of the thermal interface material can be determined.

5. A thermal interface material characterization system as defined in claim 4 wherein:
the aforementioned meter bar is a first meter bar; and
at least a portion of the plurality of thermal sensors disposed within the second thermal head forms a second meter bar to generate at least another portion of the temperature data from which the thermal characteristic of the thermal interface material can be determined.

6. A thermal interface material characterization system as defined in claim 1 wherein:
a heat flux through the thermal interface material can be directly determined from the generated temperature data.

7. A thermal interface material characterization system as defined in claim 1 further comprising:
a data analyzer electrically connected to receive the generated temperature data and which determines the thermal characteristic of the thermal interface material from the generated temperature data.

8. A thermal interface material characterization system as defined in claim 7 wherein:
the data analyzer analyzes the generated temperature data to determine whether a steady state condition has been achieved and, if so, determines the thermal characteristic of the thermal interface material.

9. A thermal interface material characterization system as defined in claim 8 further comprising:
a heater contacting the first thermal head and set to supply heat to the first thermal head;
and wherein:
upon determining that the steady state condition has been achieved, the data analyzer determines whether a heat flux through the thermal interface material is within a range of a desired heat flux;
upon determining that the heat flux through the thermal interface material is within the range of the desired heat flux, the data analyzer determines the thermal characteristic of the thermal interface material; and
upon determining that the heat flux through the thermal interface material is not within the range of the desired heat flux, the heater is reset.

10. A thermal interface material characterization system as defined in claim 7 further comprising:
a heater contacting the first thermal head and set to supply heat to the first thermal head;
and wherein:
the data analyzer analyzes the generated temperature data to predict a steady state condition that will be achieved if the heater is not reset and determines whether the predicted steady state condition is within a desired range of a desired steady state condition.

11. A thermal interface material characterization system as defined in claim 10 wherein:
upon determining that the predicted steady state condition is not within the desired range of the desired steady state condition, the heater is reset; and
upon determining that the predicted steady state condition is within the desired range of the desired steady state condition, the data analyzer further analyzes the generated temperature data until an actual steady state condition has been achieved and determines whether the actual steady state condition is within the desired range of the desired steady state condition.

12. A thermal interface material characterization system as defined in claim 11 wherein:
upon determining that the actual steady state condition is within the desired range of the desired steady state condition, the data analyzer determines whether a heat flux through the thermal interface material is within an acceptable range of a desired heat flux; and
upon determining that the heat flux through the thermal interface material is within the acceptable range of the desired heat flux, the data analyzer determines the thermal characteristic of the thermal interface material.

13. A thermal interface material characterization system comprising:
a first thermal head;
a second thermal head positioned in alignment with the first thermal head;
a thermal interface material disposed between the first and second thermal heads to allow heat to flow from the first thermal head through the thermal interface material to the second thermal head; and
a plurality of thermal sensors forming a meter bar disposed within the first and second thermal heads to generate temperature data from which a thermal characteristic of the thermal interface material can be determined.

14. A thermal interface material characterization system comprising:
a first thermal head;
a second thermal head;
a thermal interface material disposed between the first and second thermal heads and through which heat flows from the first thermal head to the second thermal head;
a plurality of thermal sensors disposed within the first and second thermal heads to generate temperature measurement data from which a heat flux through the thermal interface material can be directly determined.

15. A thermal interface material characterization system comprising:
a means for applying pressure on opposite sides of a thermal interface material and for applying steady state heat flow through the thermal interface material;
a first plurality of means for generating first steady state temperature data at a plurality of locations within the applying means;
a second plurality of means for generating second steady state temperature data at a plurality of locations within the applying means; and
a means for determining a thermal characteristic of the thermal interface material from the generated steady state temperature data.

16. A thermal interface material characterization system as defined in claim 15 further comprising:
a means for determining when a steady state condition has occurred within the thermal interface material characterization system.

17. A thermal interface material characterization system as defined in claim 16 further comprising:
a means for heating the applying means at a temperature setting; and
a means for iterating through different temperature settings at least one time to converge to the steady state condition.

18. A thermal interface material characterization system as defined in claim 16 further comprising:
a means for heating the applying means at a power level setting; and
a means for iterating through different power level settings at least one time to converge to the steady state condition.

19. A thermal interface material characterization system as defined in claim 15 further comprising:
a means for generating heat and transferring the heat to the applying means; and
a means for controlling the amount of heat generated by the heat generating means.

20. A thermal interface material characterization system as defined in claim 19 wherein:
the controlling means sets a temperature at which the heat generating means is to operate.

21. A thermal interface material characterization system as defined in claim 19 wherein:
the controlling means sets a power level for powering the heat generating means.

22. A method of characterizing a thermal interface material comprising:
placing the thermal interface material between first and second thermal heads;
applying pressure to the thermal interface material between the first and second thermal heads;
setting a heater to apply heat through the first thermal head to the thermal interface material;
measuring temperatures at a plurality of locations within the first thermal head;
measuring temperatures at a plurality of locations within the second thermal head;
determining from the measured temperatures whether a steady state condition has occurred; and
upon determining that the steady state condition has occurred, determining a thermal characteristic of the thermal interface material from the measured temperatures.

23. A method as defined in claim 22 further comprising:
directly determining a heat flux through the thermal interface material from the measured temperatures.

24. A method as defined in claim 23 further comprising:
determining a thermal resistance of the thermal interface material from the heat flux through the thermal interface material.

25. A method as defined in claim 22 further comprising:
upon determining that the steady state condition has occurred, determining whether the steady state condition is within a range of a desired steady state condition; and
upon determining that the steady state condition is within the range of the desired steady state condition, determining the thermal characteristic of the thermal interface material from the measured temperatures.

26. A method as defined in claim 25 further comprising:
upon determining that the steady state condition is not within the range of the desired steady state condition, iterating at least once through resetting the heater, re-measuring the temperatures, re-determining whether the steady state condition has occurred and re-determining whether the steady state condition is within the range of the desired steady state condition until the steady state condition is within the range of the desired steady state condition.

27. A method as defined in claim 22 further comprising:
upon determining that the steady state condition has not occurred, estimating an anticipated steady state condition;
determining whether the anticipated steady state condition is within a range of a desired steady state condition;
upon determining that the anticipated steady state condition is within the range of the desired steady state condition, re-measuring the temperatures and re-determining whether the steady state condition has occurred; and
upon determining that the anticipated steady state condition is not within the range of the desired steady state condition, resetting the heater, re-measuring the temperatures and redetermining whether the steady state condition has occurred.

28. A method as defined in claim 22 further comprising:
applying the pressure to the thermal interface material to simulate a condition in which it is desired to use the thermal interface material.

29. A method as defined in claim 22 further comprising:
setting the heater according to a desired temperature for the heater.

30. A method as defined in claim 22 further comprising:
setting the heater according to a desired power level at which the heater operates.
